(19) United States
(12) Patent Application Publication
(10) Pub. No.: US 2017/0155927 A1
(43) Pub. Date: Jun. 1, 2017

(54) METHOD, DEVICE AND SYSTEM FOR PLAYING LIVE VIDEO

(71) Applicants: Le Holdings (Beijing) Co., Ltd., Beijing (CN); LeCloud Computing Co., Ltd., Beijing (CN)

(72) Inventor: Lizhi WEI, Beijing (CN)

(21) Appl. No.: 15/245,288

(22) Filed: Aug. 24, 2016

Related U.S. Application Data
(63) Continuation of application No. PCT/CN2016/082823, filed on May 20, 2016.

(30) Foreign Application Priority Data
Nov. 26, 2015 (CN) 201510846862.0

(51) Int. Cl. H04N 21/2187; H04N 21/472; H04N 21/434; H04N 21/262; H04N 21/2362; H04N 21/234

(52) U.S. Cl. CPC H04N 21/2187; H04N 21/2362; H04N 21/234; H04N 21/4345; H04N 21/26258; H04N 21/472; H04L 67/104

(57) ABSTRACT

Disclosed are a method, a device and a system for playing live video. The method includes: sending, by a client, a play request for playing live video to a control center to enable the control center to count the number of clients viewing the live video and to return a content sharing client list to the client according to a preset policy; according to the content sharing client list returned by the control center, establishing data communication links with the clients in the list; sending subscription requests for the live video via the data communication links; receiving the packet data information sent from the clients according to the subscription requests; and combining the packet data information sent from the clients to obtain continuous live video for playing.

### CROSS-REFERENCE TO RELATED APPLICATIONS

This application is a continuation of International Application No. PCT/CN2016/082823, filed on May 20, 2016, which is based upon and claims priority to Chinese Patent Application No. 201510846862.0, filed on Nov. 26, 2015, the entire contents of which are incorporated herein by reference.

### TECHNICAL FIELD

The present disclosure generally relates to the computer technical field, and more particularly to a method, a device and a system for playing live video.

### BACKGROUND

Recently, Peer-to-Peer (“P2P”) has quickly become one of the focus topics in the computer field, and the Fortune even lists P2P as one of four technologies which will impact the future of Internet. “Peer” means “counterpart” or “companion” in the English language. Literally, P2P can be interpreted as peer-to-peer Internet. Chinese media usually refers to “P2P” as “point-to-point” or “end-to-end”, and these terminologies are collectively called as peer-to-peer computation in academic circles. Basically, P2P may be defined as follows: participants in a network share a part of hardware sources like processing capabilities, storage capacities, network connectivity and printers and the like owned by them, these shared sources, which provide services and contents via the network, can be directly accessed by other peers without intermediate entities. The participants in the network play both roles of source (service and contents) providers (servers) and source getters (clients). In terms of computing mode, P2P has broken conventional client/server (C/S) mode, and each node in a network is in an equivalent position. Each node acts as a server to provide services to other nodes, and meanwhile receives services provided by other nodes.

As present, peer-to-peer networks are widely used in many applications to share and transmit sources and files, for example, BitTorrent (“BT” or “BT download”), eMule and the like. Particularly, these networks are widely used in sharing and transmission of video files. During sharing of a video file, the video file is segmented or sectioned into a plurality of file blocks; if a user requests to obtain the video file, the user firstly sends an inquiry request to other users to determine those who have the file blocks of the video file, and then sends an obtaining request to other users according to the desired file blocks so as to obtain the video file source the user wants.

As can be seen from the above data transmission procedure, when sharing video files using a peer-to-peer network, users need to firstly determine which users have the desired video files, and then send obtaining requests to obtain corresponding video files. When such approach is applied to send stream media files like live video, the real time performance of data obtaining is relatively poor due to the limitation of the procedure steps. And, live video itself requires high real time performance and no high delay is allowed. Thus, the existing P2P mode is not suitable for real time sharing and broadcast of stream media files.

### SUMMARY

The present disclosure provides a method, a device and a system for playing live video in order to solve the problem of load imbalance caused by access to source servers by over large number of users during online live video broadcast using peer-to-peer networks.

In order to achieve the above objectives, the present disclosure provides the following technical solutions.

In a first aspect, embodiments of the present disclosure provide a method for playing live video, implemented by a client, including:

sending a play request for playing live video to a control center to enable the control center to count the number of clients viewing the live video and to return a content sharing client list to the client according to a preset policy, wherein the content sharing client list records clients sharing data of the live video with high data transmission speed and corresponding information about the clients;

according to the content sharing client list returned by the control center, establishing data communication links with the clients in the list;

sending subscription requests for the live video via the data communication links, wherein the subscription requests are packet data information configured to subscribe to the clients for the live video, and the packet data information is information about a packet of video data obtained by video sectioning;

receiving the packet data information sent from the clients according to the subscription requests; and

combining the packet data information sent from the clients to obtain continuous live video for playing.

In a second aspect, embodiments of the present disclosure provide an electronic device, including:

at least one processor; and

a memory communicably connected with the at least one processor for storing instructions executable by the at least one processor, wherein execution of the instructions by the at least one processor causes the at least one processor to perform any methods for playing live video mentioned by embodiments of the present disclosure.

In a third aspect, embodiments of the present disclosure provide an electronic device, including:

at least one processor; and

a memory communicably connected with the at least one processor for storing instructions executable by the at least one processor, wherein execution of the instructions by the at least one processor causes the at least one processor to:

receive a play request for playing live video sent from a client;

according to the play request, add the client into a player client list in which all clients playing the live video and corresponding client information of the clients are recorded;

select clients having high data transmission speed from the player client list to generate a content sharing client list; and

send the content sharing client list to the client.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flowchart illustrating a method for playing live video in accordance with some embodiments;

FIG. 2 is a flowchart illustrating a method for playing live video in accordance with some embodiments;

FIG. 3 is a flowchart illustrating a method for playing live video in accordance with some embodiments;

FIG. 4 is a block diagram illustrating a structure of a device for playing live video in accordance with some embodiments;

FIG. 5 is a block diagram illustrating a structure of a device for playing live video in accordance with some embodiments;

FIG. 6 is a block diagram illustrating a structure of a device for playing live video in accordance with some embodiments;

FIG. 7 is a block diagram illustrating a structure of a device for playing live video in accordance with some embodiments;

FIG. 8 is a block diagram illustrating a system for playing live video in accordance with some embodiments;

FIG. 9 is a block diagram illustrating a device for playing live video in accordance with some embodiments; and

FIG. 10 is a block diagram of an electronic device in accordance with some embodiments.

### DETAILED DESCRIPTION

In order to make objectives, technical solutions and advantages of embodiments of the present disclosure more clear, technical solutions in embodiments of the present disclosure will be described clearly and completely with reference to drawings of embodiments of the present disclosure. It should be noted that the following embodiments are illustrative only, rather than limiting the scope of the disclosure.

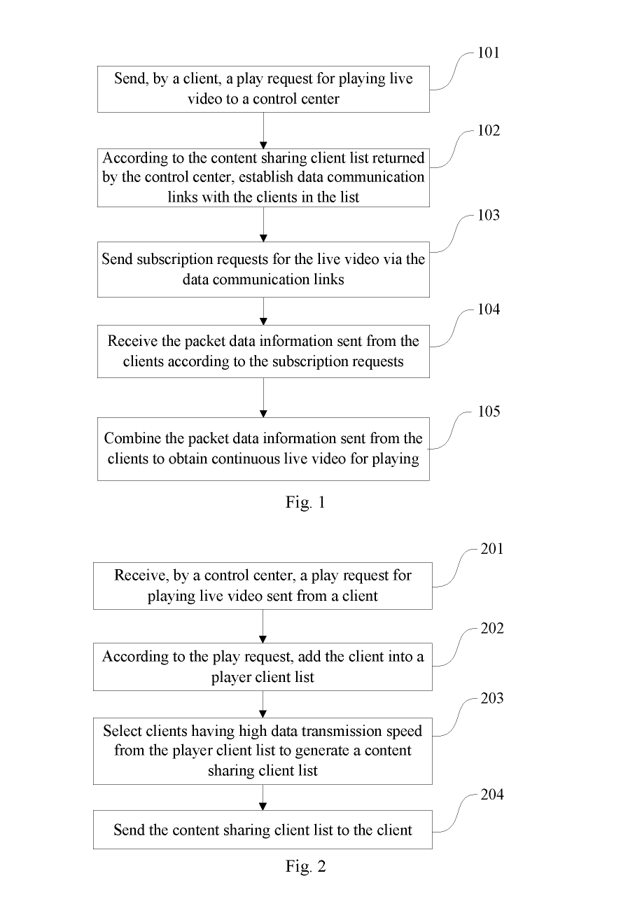

Embodiments of the present disclosure provide a method for playing live video. As shown in FIG. 1, the method can be applied in a user client for sharing and viewing live video. Specifically, the method can include the following steps.

In step 101, a client sends a play request for playing live video to a control center.

In existing approaches for playing live video, a user sends a data download request to source servers having live video data. In embodiments of the present disclosure, a client can obtain live video data in a P2P manner using peer-to-peer networks. Specifically, the client sends a play request for playing live video to a control center to determine which clients can be used for performing data sharing. The control center configures a content sharing client list according to the play request. In the list, clients can share live video data with the requesting client and relevant information corresponding to the clients (for example, user names corresponding to the clients, the IP addresses of the clients, and current network states and the like) are recorded. The clients are those playing the requested live video and have relatively high data transmission speed. The clients in the list and the requesting client form a small size P2P network.

In 102, the client establishes data communication links with the clients in the list according to the content sharing client list returned by the control center.

According to the above description regarding 101, the clients in the content sharing client list returned by the control center are not all clients playing the live video, but are some selected clients. That is, the control center can determine which clients the client used by the requesting user shall perform data sharing with, and the requesting client itself only needs to perform data sharing according to the clients listed in the content sharing client list configured by the control center. And, before data sharing, the requesting client needs to establish data communication links with these clients to realize transmission and sharing of live video data.

It shall be noted that, because embodiments of the present disclosure employ a P2P-based data transmission mode, the range of the clients is not limited to clients used by users who are viewing the live video, but can also be extended to servers having the live video data. That is to say, source servers can also be included in the content sharing client list.

In 103, the client sends subscription requests for the live video via the data communication links.

Based on the data communication links established in the previous step, the client can establish a peer-to-peer network covering a small size area with all the clients in the list. Via the peer-to-peer network, the data of the live video is shared, and the user end can obtain the live video data from different clients. In order to avoid repeatedly obtaining the same data, video data is segmented in existing P2P modes and each packet of video data is subject to sectioning process to obtain video data block which is more convenient for sending, and the position of each data block in the video can be marked. In this way, when obtaining data from the clients, the client can send an inquiry request to the clients according to its own requirements to inquire whether the clients have the desired data block; the clients determine whether they have the data block, and if the determination result is positive, the clients send response information to the client to inform it; then the client sends an obtaining request for the data block; the clients send the data block to the requesting client according to the obtaining request. When sharing and transmitting normal video files, the existing mode does not need to consider the delay of data transmission. However, with respect to live video which requires transmission having low delay, the existing P2P networks obviously cannot perform live video broadcast.

Thus, in embodiments of the present disclosure, when the client establishes communication links with the clients, the client directly sends subscription requests for the live video to the clients. The subscription requests include data information of the live video the client wants. The data information is information about a packet of data obtained after performing sectioning on the video data. That is, the client determines the need of obtaining packet data information, the clients determine whether themselves have the packet data information, and if they have, they send the packet data information to the client on their own initiative, instead of waiting for confirmation from the client and subsequent obtaining requests. Because the response mechanisms each time when obtaining video data blocks are reduced, the interactions between the client and clients are greatly reduced, and thereby the delay caused by the interactions can be decreased.

It shall be noted that segmentation or sectioning of live video can be found in conventional technologies, and embodiments of the present disclosure do not specify whether to section the video data vertically or horizontally. By identifying the segmented data blocks by sectioning, it is ensured that data blocks can be combined later to realize continuous video play.

In addition, when the client sends the subscription requests to the clients, the client determines the packet data information of the live video to be subscribed according to the number of the clients and data transmission status of the clients. For example, if there are a relatively large number of clients, the client can subscribe only one set of video data to each client; if there are a limited number of clients, the client can subscribe a plurality of packets of live video data to clients having high data transmission speed.

In 104, the client receives the packet data information sent from the clients according to the subscription requests.

In a peer-to-peer network, data sharing refers to that each client plays both roles of data receiver and data sender. Thus, after receiving the packet data information sent from the clients, the client can, acting as a client, send the received packet data information to other clients in the network which do not have such packet data.

In embodiments of the present disclosure, after receiving the subscription requests from the client, the clients determine whether they have the packet data information in conformity with the subscription requests; if they have, they directly send the packet of data information to the client. It can be seen that, unlike prior data block request, the subscription requests are requests for a set of data blocks.

It shall be noted that the distribution manner of the packet data information of the live video data is specified by the source server issuing the live video according to a certain rule. That is, when the live video data is sent, the segmentation manner, scale and how to perform sectioning are specified by the source server in advance.

In 105, the client combines the packet data information sent from the clients to obtain continuous live video for playing.

The client arranges and combines the packet data information sent from different clients according to their identifications to obtain continuous live video data for playing. Because the data is sent to the client continuously according to the subscription requests, the client can continuously synthesize data segments of the live video. Because the procedure produces very small delay, which is negligible under an ideal state, real-time live video broadcast in peer-to-peer networks can be realized.

Corresponding to the above methods, embodiments of the present disclosure further provide a method for playing live video. As shown in FIG. 2, the method is applied in a control center in a system for live broadcast of video. The control center interacts with all clients and configures local peer-to-peer networks. Specifically, the method can include the following steps.

In 201, the control center receives a play request for playing live video sent from a client.

The control center and the client communicate with each other via existing communication networks and specific communication manner is not defined in embodiments of the present disclosure. In the present embodiment, taking a CDN (content distribution network) system constructed based on IP networks for an example, the control center may be and edge CDN server in the network system, or may be a server in a relay device layer. Specific arrangements can be adjusted depending on the scale of the whole network. The control center has a function of receiving play requests for live video from all users.

The paly request can at least contain all information regarding the live video which is to be viewed by the user and user information like user name, the IP address of the client and the like. According to the user information, the control center can determine the view permission of the user, and can deny the play request from a user having no view permission, and process the request from a user having permission.

In 202, according to the play request, the control center adds the client into a player client list.

Since live video is not unique, for example, there may be different live channels or live video uploaded by different uploaders, the control center can classify the live video play requests according to different live video so that clients requesting the same live video can be classified into the same group. These requesting clients and the clients which are currently playing the live video can form a list, i.e., a player client list, which records relevant information of respective clients, at least including client names, IP addresses and current network status (upload and download rates) of the clients. The current network status of the clients can be obtained by sending keepalive packets to the control center, and however the present disclosure is not limited to this. There are many implementations to obtain the current network status in existing test technologies, and the embodiments of the present disclosure do not impose specific limitations on this.

While adding the client which sends the play request to the player client list of clients which are playing the live video, the control center deletes those clients stopping playing the live video. Thus, the accuracy and real-time performance of the player client list can be guaranteed by real-time update.

In 203, the control center selects clients having high data transmission speed from the player client list to generate a content sharing client list.

According to the player client list generated in 202, a part of clients having high data transmission speed are selected according to a preset policy, and the selected clients and their relevant information form a content sharing client list. The transmission speed can be determined by the above current network status of the clients. The specific contents of the preset policy can be set and amended by an administrator according to actual requirements of networks.

It shall be noted that, the control center selects a list of clients for the purpose of selecting users with which the client can establish a peer-to-peer network. Thus, in order to ensure the data transmission performance of individual users in the peer-to-peer network, the control center selects those clients having good data transmission performance with the client.

In 204, the control center sends the content sharing client list to the client.

The content sharing client list obtained in 203 can be sent to the client as response information to the play request for the live video sent from the client.

As can be seen from the above implementations, in the methods for playing live video provided by embodiments of the present disclosure, the existing P2P mode is modified to meet the low delay requirements of live video. The specific modifications are as follows. A client makes a request to a control center for desired live video, and receives a content sharing client list sent by the control center; then, the client sends subscription requests for live video data to the clients in the list; according to the subscription requests, the clients send the live video data in conformity with the subscription requests on their own initiative, instead of sending relevant data after receiving confirmation from the client. Meanwhile, the client obtains different parts of data contents of the live video from the clients listed in the content sharing client list, thus sharing loads of individual data sources. The client arranges and combines the live video data sent from the clients to obtain continuous live video data suitable for play. In addition, the control center is added in embodiments of the present disclosure to receive requests for live video sent from clients and perform analysis to obtain part of clients which are most suitable for sharing live video data with the client. Thus, the live video data can be efficiently used among the part of clients to reduce the load of the source server which has the live video data. As compared prior live video broadcast approach, embodiments of the present disclosure reduce the access mechanisms in data transmission between clients and limit the node range for performing data sharing in the P2P networks, so as to meet the low delay requirements in data transmission of live video. Using the technical solutions in the present disclosure, live video can be broadcast online using P2P networks, thereby solving the problem of serious load imbalance caused by a large number of accesses to source servers having the live video data.

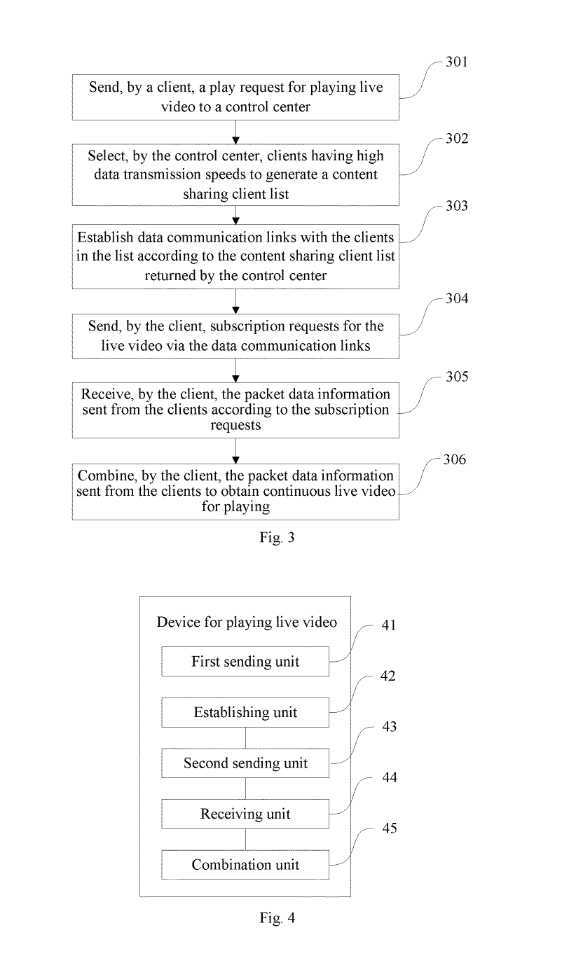

In order to describe the method for playing live video described by embodiments of the present disclosure in further details, the following description will combine the above two methods. As shown in FIG. 3, the method includes the following specific steps.

In 301, a client sends a play request for playing live video to a control center.

In this step, the client sends the play request for playing live video to the control center and control center receives the play request based on the networks which are previously described in 201. Thus, the above descriptions regarding the steps 101 and 201 also apply here, and thus repeated descriptions are omitted.

In 302, according to the play request, the control center selects clients having high data transmission speed to generate a content sharing client list.

Before receiving the play request, the control center determines live video which is currently played in the system and creates a single player client list for each live video. The list records the clients which are currently playing the same live video and corresponding information of the clients.

After obtaining player client lists, the control center identifies the received play request to determine the player client list which the client belongs to according to the information about the live video carried in the play request, and adds the client and corresponding client information into the list. Meanwhile, the control center selects a plurality of clients having high transmission speed from the list to generate a content sharing client list. Specific selection policy can be as follows: the control center ranks the clients in the player client list, and then with the premise that the selected clients shall be located in the same geographical area or served by the same operator with the client sending the request, and taking the current network status of each client (i.e., data transmission speed) into account, the control center takes a plurality of clients with a high rank as candidate clients. Then, according to specific video sending rules, i.e., segmentation rules of live video data, the control center selects a corresponding number of clients as the clients. The segmentation rules of the live video data may be obtained by the control center from the source server sending the live video. For example, the segmentation rule of the live video data obtained by the control center can be as follows: one video data segment is divided into five packets, and then top five clients in the player client list can be selected as the clients, and the selected clients and corresponding client information can form the content sharing client list.

In 303, the client establishes data communication links with the clients in the list according to the received content sharing client list.

The control center sends the content sharing client list generated in 302 into the client as response information to the play request from the client. According to the received content sharing client list, the client parses the list, and establishes data communication links with the clients in the list. Thus, a small-size P2P network architecture is established between the client and the clients.

In 304, the client sends subscription requests for the live video to the clients via the data communication links.

While the peer-to-peer network is established, the client distributes the contents of the subscription requests to different clients according to a preset policy. Because the policy is designed for sending live video data, the policy focuses on the data transmission status of the clients. For example, in the above example, the client can assign the requests for five different packets of data to five different clients, and if there are four available clients, the client selects to send a request for two packets of data to the client having the highest data transmission speed. The specific contents of the policy can be amended by the administrator at any time according to actual requirements.

In 305, the client received the packet data information sent from the clients according to the subscription requests.

After the client sends the subscription requests, the clients send the packet data information in conformity with the requests owned by themselves to the client according to the packet data request in the subscription requests.

It shall be noted that the client sends the subscription requests to the clients when the P2P network is established, and the requests are sent only for once, and then the clients can continuously send the packet data information in conformity with the subscription rule throughout the whole broadcast of the live video.

In 306, the client combines the packet data information sent from the clients to obtain continuous live video for playing.

After obtaining the packet data information sent from the clients, the client can classify the information according to sources of the information and meanwhile extract identification information in the packet data information. The identification information is configured to indicate the specific position of the packet data information in the live video. For example, when a video file is sent, the video file is divided into several segments, and each segment is divided into data packets of the same size. As such, one data packet can be labeled with identification information indicating which segment the data packet belongs to and the packet number of the data packet. According to the identification information, the client can integrate the separated packet data information into continuous video data and play the video in real time.

Further, embodiments of the present disclosure provide a device for playing live video to implement the above methods. The device may be provided in a client for viewing live video. As shown in FIG. 4, the device can include a first sending unit 41, an establishing unit 42, a second sending unit 43, a receiving unit 44 and a combination unit 45.

The first sending unit 41 is configured to send, in a client, a play request for playing live video to a control center to enable the control center to count the number of clients which request to view the live video and to return a content sharing client list to the client according to a preset policy, wherein the content sharing client list records clients sharing data of the live video with high data transmission speed and corresponding address information about the clients.

The establishing unit 42 is configured to, according to the content sharing client list returned by the control center, establish data communication links with the clients in the list.

The second sending unit 43 is configured to send subscription requests for the live video via the data communication links established by the establishing unit 42, wherein the subscription requests are packet data information configured to subscribe to the clients for the live video, and the packet data information is information about a packet of video data obtained by video sectioning.

The receiving unit 44 is configured to receive the packet data information sent from the clients according to the subscription requests sent by the second sending unit 43.

The combination unit 45 is configured to combine the packet data information sent from the clients to obtain continuous live video for playing.

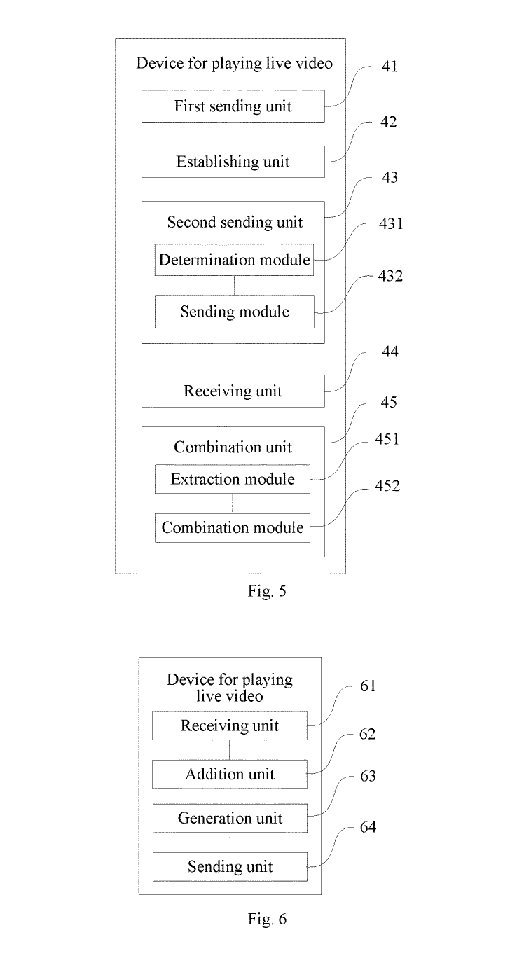

Further, as shown in FIG. 5, the second sending unit 43 can include a determination module 431 and a sending module 432.

The determination module 431 is configured to determine the packet data information of the live video to be subscribed to the clients according to a preset policy.

The sending module 432 is configured to send the subscription requests carrying the packet data information determined by the determination module 431 to enable the clients to send corresponding packet data information of the live video according to the subscription requests.

Further, as shown in FIG. 5, the combination unit 45 can include an extraction module 451 and a combination module 452.

The extraction module 451 is configured to extract, from the packet data information, identification information which records the position of the packet data information in the live video.

The combination module 452 is configured to combine the packet data information sent from the clients using the identification information extracted by the extraction module 451 to form continuous live video data.

Further, embodiments of the present disclosure provide a device for playing live video. The device may be provided in a control center which specifically can be a server or a client in a network. As shown in FIG. 6, the device can include a receiving unit 61, an addition unit 62, a generation unit 63, and a sending unit 64.

The receiving unit 61 is configured to receive, in a control center, a play request for playing live video sent from a client.

The addition unit 62 is configured to, according to the play request received by the receiving unit 61, add the client into a player client list in which all clients which are playing the live video and corresponding client information of the clients are recorded.

The generation unit 63 is configured to select clients having high data transmission speed from the player client list to generate a content sharing client list.

The sending unit 64 is configured to send the content sharing client list generated by the generation unit 63 to the client.

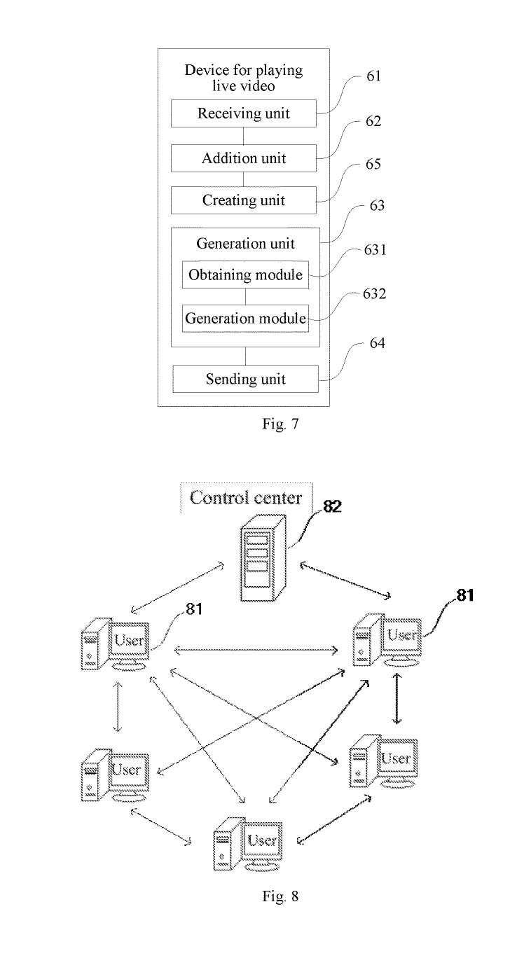

Further, as shown in FIG. 7, the device further includes a creating unit 65.

The creating unit 65 is configured to create a player client list for live video which is currently being broadcast before the addition unit 62 adds the client into the player client list according to the play request.

Further, as shown in FIG. 7, the generation unit 63 can include an obtaining module 631 and a generation module 632.

The obtaining module 631 is configured to obtain current data transmission speeds of all clients in the player client list.

The generation module 632 is configured to select a plurality of clients having high data transmission speed according to the data transmission speeds obtained by the obtaining module 631 to generate the content sharing client list.

Further, embodiments of the present disclosure provide a system for playing live video. As shown in FIG. 8, the system can include a client 81 including the device for playing live video as mentioned above, and a control center 82 including the device for playing live video as mentioned above.

The client 81 client sends a play request for playing live video to the control center 82; according to a content sharing client list returned by the control center 82, establishes data communication links with the clients in the list; sends subscription requests for the live video via the data communication links; receives packet data information of the live video sent from the clients according to the subscription requests; and finally combines the packet data information sent from the clients to obtain continuous live video data and play the live video.

The control center 82 receives the play request for playing live video sent from the client 81; according to the play request, adds the client into a player client list in which all clients which are playing the live video and corresponding client information of the clients are recorded; and meanwhile, selects clients having high data transmission speed from the player client list to generate a content sharing client list; and sends the content sharing client list to the client.

In view of the above, in the methods, devices and system for playing live video provided by embodiments of the present disclosure, the existing P2P mode is modified to meet the low delay requirements of live video. The specific modifications are as follows. A client makes a request to a control center for desired live video, and receives a content sharing client list sent by the control center; then, the client sends subscription requests for live video data to the clients in the list; according to the subscription requests, the clients send the live video data in conformity with the subscription requests on their own initiative, instead of sending relevant data after receiving confirmation from the client. Meanwhile, the client obtains different parts of data contents of the live video from the clients listed in the content sharing client list, thus sharing loads of individual data sources. The client arranges and combines the live video data sent from the clients to obtain continuous live video data suitable for playing. In addition, the control center is added in embodiments of the present disclosure to receive requests for live video sent from clients and perform analysis to obtain a part of clients which are most suitable for sharing live video data with the client. Thus, the live video data can be efficiently used among the part of clients to reduce the load of the source server which has the live video data. As compared prior live video broadcast approach, the present disclosure reduces the access mechanisms in data transmission between clients and limits the node range for performing data sharing in the P2P networks, so as to meet the low delay requirements of data transmission. Using the technical solutions in the present disclosure, live video can be broadcast online using P2P networks, thereby solving the problem (in conventional modes) of load imbalance caused by a large number of accesses to source servers having the live video data.

It shall be noted that the functions of respective units or modules in the above devices for playing live video according to embodiments of the present disclosure can be realized by hardware processors.

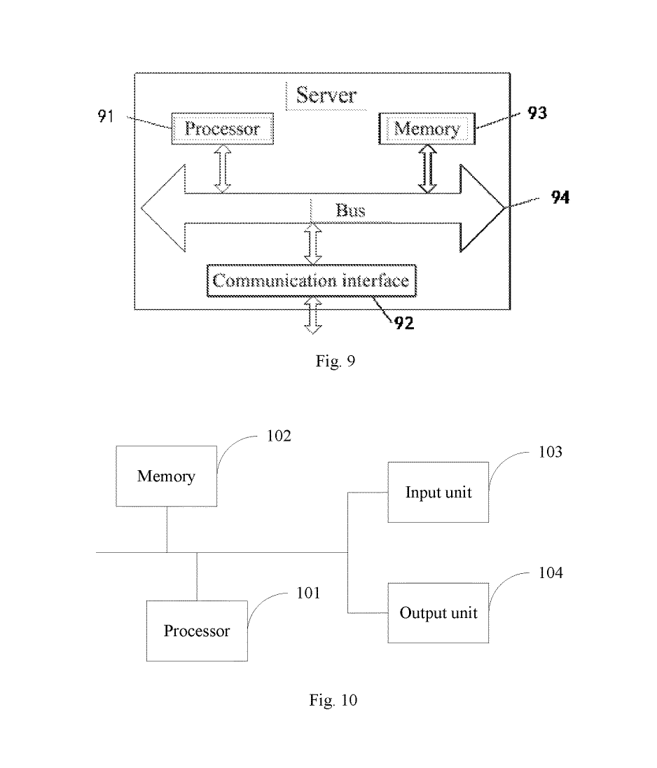

As an example, FIG. 9 is a block diagram showing a device for playing live video according to an embodiment of the present disclosure. In the embodiment, the device for playing live video is provided in a physical server which can include a processor 91, a communication interface 92, a memory 93 and a bus 94. The processor 91, the communication interface 92 and the memory 93 communicate with each other via the bus 94. The communication interface 92 may be used for information transmission between the server and a client. The processor 91 invokes logic instructions in the memory 93 to perform the following method: a client sending a play request for playing live video to a control center to enable the control center to count the number of clients which request to view the live video and to return a content sharing client list to the client according to a preset policy, wherein the content sharing client list records clients sharing data of the live video with high data transmission speed and corresponding information about the clients; according to the content sharing client list returned by the control center, establishing data communication links with the clients in the list; sending subscription requests for the live video via the data communication links, wherein the subscription requests are packet data information configured to subscribe to the clients for the live video, and the packet data information is information about a packet of video data obtained by video sectioning; receiving the packet data information sent from the clients according to the subscription requests; and combining the packet data information sent from the clients to obtain continuous live video for play.

In addition, the logic instructions in the memory 93 may be implemented as software functional units which can be stored in a computer readable storage medium when sold or used as independent products. Based on such understanding, the essence of or a part of the technical solutions in the present disclosure (that is, the part making contributions over prior arts) may be embodied as software products. The computer software products may be stored in a storage medium including instructions which enable a computer device (for example, a personal computer, a server or a network device, and so on) to perform whole or a part of the steps in the methods according to various embodiments of the present disclosure. The above mentioned storage medium can include various mediums capable of storing program codes, for example, a USB flash drive, a mobile hard disk drive, a read only memory (ROM), a random access memory (RAM), a magnetic disk or an optical disk, and so on.

Further, an embodiment of the present disclosure further provides a non-transitory computer-readable storage medium storing executable instructions, which can be executed by an electronic device to perform any methods for playing live video mentioned by embodiments of the present disclosure.

FIG. 10 is a block diagram of an electronic device which is configured to perform the methods for playing live video according to an embodiment of the present disclosure. As shown in FIG. 10, the device includes: one or more processors 101 and memory 102. A processor 101 is showed in FIG. 10 for an example.

Device which is configured to perform the methods for playing live video can also include: input unit 103 and output unit 104.

Processor 101, memory 102, input unit 103 and output unit 104 can be connected by BUS or other methods, and BUS connecting is showed in FIG. 10 for an example.

Memory 102 can be used for storing non-transitory software program, non-transitory computer executable program and modules as a non-transitory computer-readable storage medium, such as corresponding program instructions/modules for the methods for playing live video mentioned by embodiments of the present disclosure (such as shown in FIG. 4, first sending unit 41, establishing unit 42, second sending unit 43, receiving unit 44 and combination unit 45). Processor 101 performs kinds of functions and playing live video of the electronic device by executing non-transitory software program, instructions and modules which are stored in memory 102, thereby realizes the methods for playing live video mentioned by embodiments of the present disclosure.

Memory 102 can include program storage area and data storage area, thereby the operating system and applications required by at least one function can be stored in program storage area and data created by using the device for playing live video can be stored in data storage area. Furthermore, memory 102 can include high speed Random-access memory (RAM) or non-volatile memory such as magnetic disk storage device, flash memory device or other non-volatile solid state storage devices. In some embodiments, memory 102 can include long-distance setup memories relative to processor 101, which can communicate with the device for playing live video by networks. The examples of said networks are including but not limited to Internet, Intranet, LAN, mobile Internet and their combinations.

Input unit 103 can be used to receive inputted number, character information and key signals causing user configures and function controls of the device for playing live video. Output unit 104 can include a display screen or a display device.

The said module or modules are stored in memory 102 and perform the methods for playing live video when executed by one or more processors 101.

The said device can reach the corresponding advantages by including the function modules or performing the methods provided by embodiments of the present disclosure. Those methods can be referenced for technical details which may not be completely described in this embodiment.

Electronic devices in embodiments of the present disclosure can be existences with different types, which are including but not limited to:

(1) Mobile Internet devices: devices with mobile communication functions and providing voice or data communication services, which include smartphones (e.g. iPhone), multimedia phones, feature phones and low-cost phones.

(2) Super mobile personal computing devices: devices belong to category of personal computers but mobile internet function is provided, which include PAD, MID and UMPC devices, e.g. iPad.

(3) Portable recreational devices: devices with multimedia displaying or playing functions, which include audio or video players, handheld game players, e-book readers, intelligent toys and vehicle navigation devices.

(4) Servers: devices with computing functions, which are constructed by processors, hard disks, memories, system BUS, etc. For providing services with high reliabilities, servers always have higher requirements in processing ability, stability, reliability, security, expandability, manageability, etc., although they have a similar architecture with common computers.

(5) Other electronic devices with data interacting functions.

The embodiments of devices are described above only for illustrative purposes. Units described as separated portions may be or may not be physically separated, and the portions shown as respective units may be or may not be physical units, i.e., the portions may be located at one place, or may be distributed over a plurality of network units. A part or whole of the modules may be selected to realize the objectives of the embodiments of the present disclosure according to actual requirements.

In view of the above descriptions of embodiments, those skilled in this art can well understand that the embodiments can be realized by software plus necessary hardware platform, or may be realized by hardware. Based on such understanding, it can be seen that the essence of the technical solutions in the present disclosure (that is, the part making contributions over prior arts) may be embodied as software products. The computer software products may be stored in a computer readable storage medium including instructions, such as ROM/RAM, a magnetic disk, an optical disk, to enable a computer device (for example, a personal computer, a server or a network device, and so on) to perform the methods of all or a part of the embodiments.

It shall be noted that the above embodiments are disclosed to explain technical solutions of the present disclosure, but not for limiting purposes. While the present disclosure has been described in detail with reference to the above embodiments, those skilled in this art shall understand that the technical solutions in the above embodiments can be modified, or a part of technical features can be equivalently substituted, and such modifications or substitutions will not make the essence of the technical solutions depart from the spirit or scope of the technical solutions of various embodiments in the present disclosure.

What is claimed is:

1. A method for playing live video, implemented by a client, comprising:
sending a play request for playing live video to a control center to enable the control center to count the number of clients viewing the live video and return a content sharing client list to the client according to a preset policy, wherein the content sharing client list records clients sharing data of the live video with high data transmission speed and corresponding information about the clients;
according to the content sharing client list returned by the control center, establishing data communication links with the clients in the list;
sending subscription requests for the live video via the data communication links, wherein the subscription requests are packet data information configured to subscribe to the clients for the live video, and the packet data information is information about a packet of video data obtained by video sectioning;
receiving the packet data information sent from the clients according to the subscription requests; and
combining the packet data information sent from the clients to obtain a continuous live video for playing.

2. The method according to claim 1, wherein sending the subscription requests for the live video via the data communication links comprises:
determining the packet data information of the live video to be subscribed to the clients according to a preset policy; and
sending the subscription requests carrying the packet data information to enable the clients to send corresponding packet data information of the live video according to the subscription requests.

3. The method according to claim 1, wherein combining the packet data information sent from the clients to obtain continuous live video for playing comprises:
extracting, from the packet data information, identification information which records the position of the packet data information in the live video; and
combining the packet data information sent from the clients using the identification information to form continuous live video data.

4. The method according to claim 2, wherein parameters in the preset policy comprise the number of the clients and data transmission status of each client.

5. An electronic device, comprising:
at least one processor; and
a memory communicably connected with the at least one processor for storing instructions executable by the at least one processor, wherein execution of the instructions by the at least one processor causes the at least one processor to:
send a play request for playing live video to a control center to enable the control center to count the number of clients viewing the live video and return a content sharing client list to the client according to a preset policy, wherein the content sharing client list records clients sharing data of the live video with high data transmission speed and corresponding information about the clients;
according to the content sharing client list returned by the control center, establish data communication links with the clients in the list;
send subscription requests for the live video via the data communication links, wherein the subscription requests are packet data information configured to subscribe to the clients for the live video, and the packet data information is information about a packet of video data obtained by video sectioning;
receive the packet data information sent from the clients according to the subscription requests; and
combine the packet data information sent from the clients to obtain a continuous live video for playing.

6. The electronic device according to claim 5, wherein sending the subscription requests for the live video via the data communication links comprises:
determining the packet data information of the live video to be subscribed to the clients according to a preset policy; and
sending the subscription requests carrying the packet data information to enable the clients to send corresponding packet data information of the live video according to the subscription requests.

7. The electronic device according to claim 5, wherein combining the packet data information sent from the clients to obtain continuous live video for playing comprises:
extracting, from the packet data information, identification information which records the position of the packet data information in the live video; and
combining the packet data information sent from the clients using the identification information to form continuous live video data.

8. The electronic device according to claim 6, wherein parameters in the preset policy comprise the number of the clients and data transmission status of each client.

9. An electronic device, comprising:
at least one processor; and
a memory communicably connected with the at least one processor for storing instructions executable by the at least one processor, wherein execution of the instructions by the at least one processor causes the at least one processor to:
receive a play request for playing live video sent from a client;
according to the play request, add the client into a player client list in which all clients playing the live video and corresponding client information of the clients are recorded;
select clients having high data transmission speed from the player client list to generate a content sharing client list; and
send the content sharing client list to the client.

10. The electronic device according to claim 9, wherein before adding the client into the player client list according to the play request, wherein the instructions are executed to cause the at least one processor to:
create a player client list for live video which is currently being broadcast.

11. The electronic device according to claim 9, wherein selecting clients having high data transmission speed from the player client list to generate a content sharing client list comprises:
obtaining current data transmission speeds of all clients in the player client list; and
selecting a plurality of clients having high data transmission speed to generate the content sharing client list.
